(19) United States
(12) Patent Application Publication
(10) Pub. No.: US 2004/0139167 A1
(43) Pub. Date: Jul. 15, 2004

(54) Apparatus and method for a scalable network attach storage system

(75) Inventors: Thomas James Edsall, Cupertino, CA (US); Mario Mazzola, San Jose, CA (US); Prem Jain, Fremont, CA (US); Silvano Gai, San Jose, CA (US); Luca Cafiero, Palo Alto, CA (US); Maurilio De Nicolo, Saratoga, CA (US)

Correspondence Address: BEYER WEAVER & THOMAS LLP, P.O. BOX 778, BERKELEY, CA, 94704-0778, US

(73) Assignee: Andiamo Systems Inc., A Delaware Corporation, San Jose, CA

(21) Appl. No.: 10/313,306

(22) Filed: Dec. 6, 2002

(51) Int. Cl. G06F 15/167

(52) U.S. Cl. 709/212

(57) ABSTRACT

An apparatus and method for a scalable network attached storage system. The apparatus includes a scalable network attached storage system, the network attached storage system including one or more termination nodes, one or more file server nodes for maintaining file systems, one or more disk controller nodes for accessing storage disks respectively, and a switching fabric coupling the one or more termination node, file server nodes, and disk controller nodes. The one or more termination nodes, file server nodes and disk controller nodes can be scaled as needed to meet user demands. The method includes receiving a connection request from a client, selecting a termination node among the plurality of termination nodes to establish a connection with the client in response to the connection request based on a predetermined metric, terminating at the selected termination node a command request received from the client during the connection by extracting a file handle defined by the command request, forwarding the command request to a selected file server node among a plurality of file server nodes interpreting the command request at the selected file server node and accessing an appropriate disk controller node among a plurality of disk controller nodes, and accessing disk storage through the appropriate disk controller node and serving the accessed data to the client. The number of termination nodes, file server nodes, and disk controller nodes are scalable as needed to meet user demands.

### RELATED APPLICATIONS

The present invention is related to U.S. Application Ser. No. ______ (attorney docket number ANDIP023) entitled “Apparatus and Method for A High Availability Data Network Using Replicated Delivery” by Thomas Edsall et. al. and U.S. application Ser. No. ______ (attorney docket number ANDIP018) entitled “Apparatus and Method for a Lightweight, Reliable Packet-Based Protocol” by Gai Silvano et. al., both filed on the same day and assigned to the same assignee as the present invention, and incorporated herein by reference for all purposes.

### BACKGROUND OF THE INVENTION

1. Field of the Invention

The present invention relates to data storage, and more particularly, to an apparatus and method for a scalable Network Attached Storage (NAS) system.

2. Background of the Invention

With the increasing popularity of Internet commerce and network centric computing, businesses and other organizations are becoming more and more reliant on information. To handle all of this data, various types of storage systems have been developed such as Storage Array Networks (SANs) and Network Attached Storage (NAS). SANs have been developed based on the concept of storing and retrieving data blocks. In contrast, NAS systems are based on the concept of storing and retrieving files.

A typical NAS system is a single monolithic node that performs protocol termination, maintains a file system, manages disk space allocation and includes a number of disks, all managed by one processor at one location. Protocol termination is the conversion of NFS or CIFS requests over TCP/IP received from a client over a network into whatever internal inter-processor communication (IPC) mechanism defined by the operating system relied on by the system. Some NAS system providers, such as Network Appliance of Sunnyvale, Calif., market NAS systems that can process both NFS and CIFS requests so that files can be accessed by both Unix and Windows users respectively. With these types of NAS systems, the protocol termination node includes the capability to translate both NFS or CIFS requests into whatever communication protocol is used within the NAS system. The file system maintains a log of all the files stored in the system. In response to a request from the termination node, the file system retrieves or stores files as needed to satisfy the request. The file system is also responsible for managing files stored on the various storage disks of the system and for locking files that are being accessed. The locking of files is typically done whenever a file is open, regardless if it is being written to or read. For example, to prevent a second user from writing to a file that is currently being written to by a first user, the file is locked. A file may also be locked during a read to prevent another termination node from attempting to write or modify that file while it is being read. The disk controller handles a number of responsibilities, such as accessing the disks, managing data mirroring on the disks for back-up purposes, and monitoring the disks for failure and/or replacement. The storage disk are typically arranged in one of a number of different well known configurations, such as a known level of Redundant Array of Independent Disks (i.e., RAID1 or RAID5).

The protocol termination node and file system are usually implemented in microcode or software on a computer server operating either the Windows, Unix or Linux operating systems. Together, the computer, disk controller, and array of storage disks are then assembled into a rack. A typical NAS system is thus assembled and marketed as a stand alone rack system.

A number of problems are associated with current NAS systems. Foremost, most NAS systems are not scaleable. Each NAS system rack maintains its own file system. The file system of one rack does not inter-operate with the file systems of other racks within the information technology infrastructure of an enterprise. It is therefore not possible for the file system of one rack to access the disk space of another rack or vice versa. Consequently, the performance of NAS systems is typically limited to that of single rack system. Certain NAS systems are redundant. However, even these systems do not scale very well and are typically limited to only two or four nodes at most.

Due to the aforementioned problems, the benchmarks (for example the access rate and the overall response time) used to measure the performance of NAS systems are relatively poor or even contrived. Often several of these independent systems will be used in parallel to get an aggregate performance. This is not true scaling, however, as these aggregate systems are typically not coordinated.

There are also many drawbacks associated with individual NAS systems. Individual NAS systems all have restrictions on the number of users that can access the system at any one time, the number of files that can be served at one time, and the data throughput (i.e., the rate or wait time before requested files are served). When there are many files stored on an NAS system, and there are many users, a significant amount of system resources are dedicated to managing overhead functions such as the locking of particular files that are being access by users. This overhead significantly impedes the overall performance of the system.

Another problem with existing NAS solutions is that the performance of the system cannot be tuned to the particular workload of an enterprise. In a monolithic system, there is a fixed amount of processing power that can be applied to the entire solution independent of the work load. However, some work loads require more bandwidth than others, some require more I/Os per second, some require very large numbers of files with moderate bandwidth and users, and still others require very large total capacity with limited bandwidth and a limited total number of files. Existing systems typically are not very flexible in how the system can be optimized for these various work loads. They typically require the scaling of all components equally to meet the demands of perhaps only one dimension of the work load such as number of I/Os per second.

Another problem is high availability. This is similar to the scalability problem noted earlier where two or more nodes can access the same data at the same time, but here it is in the context of take over during a failure. Systems today that do support redundancy typically do in a one-to-one (1:1) mode whereby one system can back up just one other system. Existing NAS systems typically do not support the redundancy for more than one other system.

An NAS architecture that enables multiple termination nodes, file systems, and disk controller nodes to be readily added to the system as required to provide scalability, improve performance and to provide high availability redundancy is therefore needed.

### SUMMARY OF THE INVENTION

To achieve the foregoing, and in accordance with the purpose of the present invention, an apparatus and method for a scalable network attached storage system is disclosed. The apparatus includes a scalable network attached storage system, the network attached storage system including one or more termination nodes, one or more file server nodes for maintaining file systems, one or more disk controller nodes for accessing storage disks respectively, and a switching fabric coupling the one or more termination node, file server nodes, and disk controller nodes. The one or more termination nodes, file server nodes and disk controller nodes can be scaled as needed to meet user demands. The method includes receiving a connection request from a client, selecting a termination node among the plurality of termination nodes to establish a connection with the client in response to the connection request based on a predetermined metric, terminating at the selected termination node a command request received from the client during the connection by extracting a file handle defined by the command request, forwarding the command request to a selected file server node among a plurality of file server nodes interpreting the command request at the selected file server node and accessing an appropriate disk controller node among a plurality of disk controller nodes, and accessing disk storage through the appropriate disk controller node and serving the accessed data to the client. The number of termination nodes, file server nodes, and disk controller nodes are scalable as needed to meet user demands.

### BRIEF DESCRIPTION OF THE DRAWINGS

FIG. 1 is a block diagram of a NAS system having a scalable architecture according to the present invention.

FIGS. 2A and 2B are flow diagrams illustrating the operation of a load balancer of the NAS system of the present invention.

FIG. 3 is a flow chart illustrating the operation of termination nodes in the NAS system of the present invention.

FIGS. 4A through 4C are flow diagrams illustrating how the NAS system processes a request from a client according to the present invention.

FIG. 5 is a block diagram illustrating an actual implementation of the NAS system according to one embodiment of the of the present invention.

### DETAILED DESCRIPTION OF THE PREFERRED EMBODIMENTS

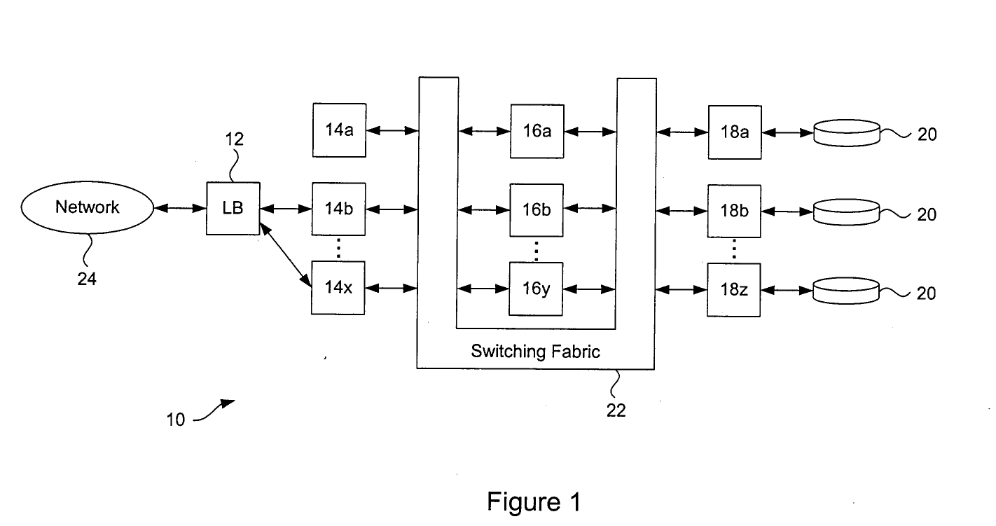

Referring to FIG. 1, a block diagram of NAS system having a scalable architecture according to the present invention is shown. The NAS system 10 includes a load balancer 12, one or more termination nodes 14a through 14x, one or more file server nodes 16a through 16y, one or more disk controller nodes 18a through 18z, and a plurality of disks 20. A switching fabric 22 is provided to interconnect the termination nodes 14a through 14x, the file server nodes 16a through 16y, and the disk controller nodes 18a though 18z. In an alternative embodiment, a Storage Array Network (not shown) could be used between the disk controller nodes 18a through 18z and the disks 20. The NAS system is connected to a network 24 through a standard network interconnect. The network 24 can be any type of computing network including a variety of servers and users running various operating systems such as Windows, Unix, Linux, or a combination thereof.

The load balancer 12 receives requests to access files stored on the NAS system 10 from users on the network 24. The main function performed by the load balancer 12 is to balance the number of active connections among the one or more termination nodes 14a through 14x. In other words, the load balancer 12 dynamically assigns user connections so that no one termination node 14 becomes a “bottleneck” due to handling too many connections. In a system 10 having three termination nodes 14 for example, if the first, second and third termination nodes 14 are handling seven (7), eleven (11), and three (3) connections respectively, then the load balancer 12 will forward the next connections to the third termination node 14 since it is handling the fewest number of connections. The load balancer 12 also redistributes connections among remaining termination nodes 14 in the event one fails or in the event a new termination node 14 is added to the NAS system 10. The load balancer 12 can also use other metrics to distribute the load among the various termination nodes 14. For example, the load balancer 12 can distribute the load based on CPU utilization, memory utilization and the number of connections, or any combination thereof.

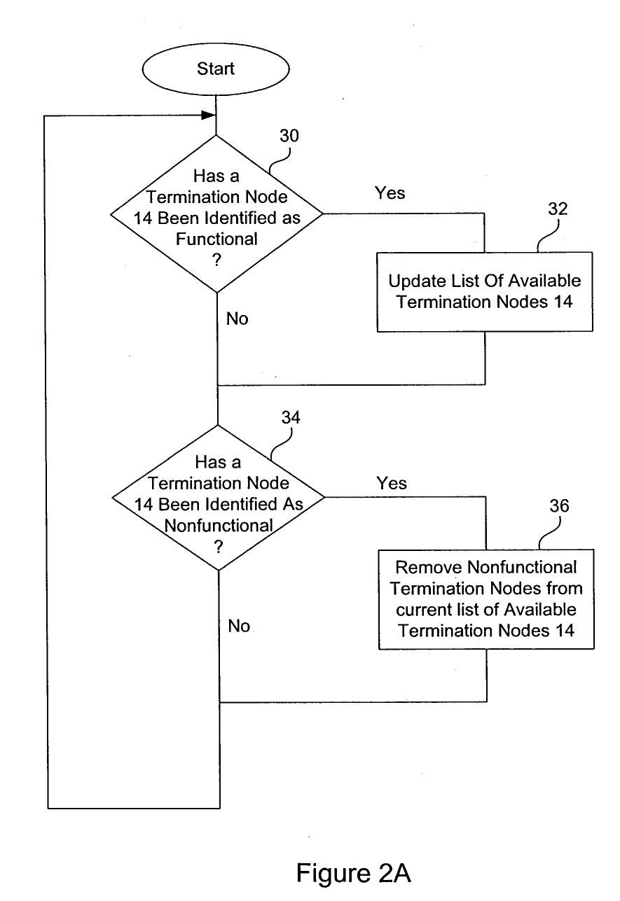

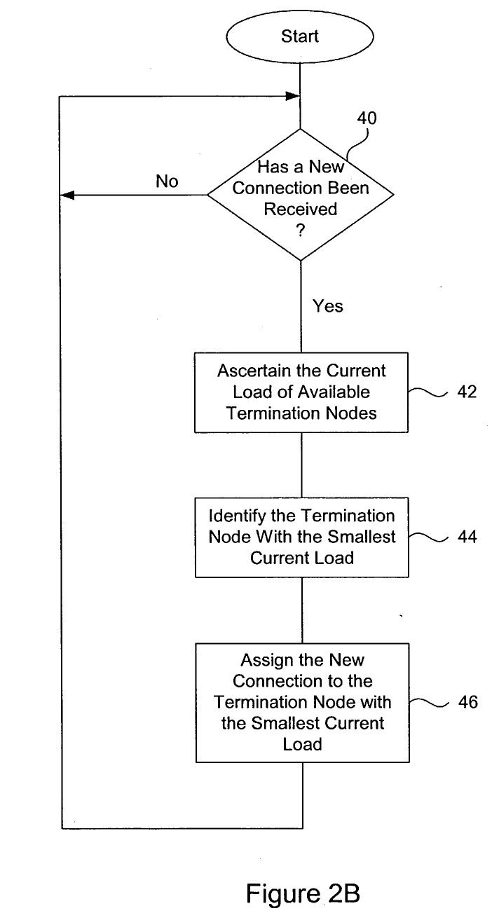

Referring to FIGS. 2A and 2B, flow diagrams illustrating the operation of the load balancer 12 of the present invention are shown. Flow diagram 2A illustrates the sequence of the load balancer 12 in maintaining a current list of the available termination nodes 14 in the NAS system 10. FIG. 2B illustrates the sequence of the load balancer 12 in balancing the load of connections among the current list of available termination nodes.

In FIG. 2A, the load balancer 12 sequences through the following routine. Initially the load balancer 12 determines if a new termination node 14 has been identified as functional (decision diamond 30). If yes, then the list of available termination nodes 14 is updated to include the new termination node 14 (box 32). Regardless if a new termination node 14 has been added or not, the load balancer 12 next determines if any of the available termination nodes 14 is non-functional (decision diamond 34). If yes, the non-functional termination node is removed from the available list (box 36). Regardless if a non-functional termination node 14 has been identified or not, the aforementioned sequence is repeated (control is returned to diamond 30). In this manner, the load balancer 12 is constantly updating the list of available termination nodes 14 in the NAS system 10.

In FIG. 2B, the sequence for balancing connection loads among the available termination nodes 14 of the NAS system 10 is shown. Initially the load balancer 12 determines if it has received a new connection (decision diamond 40). If yes, the load balancer 12 ascertains the current load of each of the available termination nodes 14 in the system 10 (box 42). The termination node 14 with the smallest current load is then identified (box 44). The new connection is then assigned to the termination node 14 with the smallest load (box 46). The aforementioned sequence is repeated for subsequent requests. In this manner, the load balancer 12 is able to prevent bottlenecks by evenly distributing connections loads among the termination nodes 14 of the NAS system 10. As previously noted, the number of connections is but one metric that can be used by the load balancer 12. Other metrics such as CPU utilization and memory utilization could be used. With these embodiments, these other metrics alone or in combination would be considered by the load balancer 12 in assigning a new connection to a termination node 14. It should be noted that once a connection is made to a termination node 14, all subsequent received requests or packets associated with that connection are usually sent to the same termination node 14.

The termination nodes 14 each perform a number of functions. The termination nodes 14 terminate connection requests received through the load balancer 12 from clients over the network 24. The received connection requests are typically TCP/IP or UDP/IP protocol messages. Termination involves the conversion or translation of the upper layer protocols, usually either NFS or CIFS, into the communication protocol used by the switching fabric 22. The termination nodes 14 also determine which file server node 16 will receive the translated request based on the content of the received NFS or CIFS request. The termination nodes 14 also terminates XDR and RPC messages when NFS requests are received, maintains additional state information with CIFS messages, and is capable of detecting the failure of any of the server nodes 16. XDR is an External Data Representation and RPC is Remote Procedure Call. These are protocol layers between TCP and NFS. XDR creates a standard data format so that different operating systems can communicate in a common way and RPC allows one machine to run procedures on a remote machine. In CIFS, the file handle is not global, i.e. it is specific to the connection. This means that each connection for CIFS can have a different file handle for the same file. Since it is desirable for all of the TCP/IP terminations nodes 14 to make the same decision as to which 16 node is responsible for a given file independent of the connection, the CIFS handle has to be translated into the handle used internally for the file. Failures may be detected in a number of known ways, for example by sending out periodic messages and acknowledgements between the nodes 16 and the nodes 14.

The selection of the file server node 16a through 16y may depend on a number of factors. One such factor is the range of the file handles served by each file server node 16. When a request is received, the termination node routes the request based on the file handle defined by the request. For example, file server node 16a may be assigned file handle range 100 to 499, file server node 16b may be assigned file handle range 500 to 699, and file server node 16c may be assigned file handle range 700 to 999, etc. Whenever a request is received, the responsible termination node 14 will forward the request to the appropriate file server node 16 based on the file handle defined by the request. It should be noted that the file ranges mention herein are only exemplary and they should in no way be construed as some how limiting the invention.

In other embodiments, certain file server nodes 16 can be pre-assigned to handle certain types of files. For example, if one of the file server nodes 16 is designated to access MPEG files, then any MPEG request is automatically routed by the termination node 14 handling that request to the designated MPEG file server node 16. Examples of other types of files that may have a dedicated file server node 16 include “.doc”, web pages identified by htm or html, or images identified by .jpg, .gif, .bmp, etc.

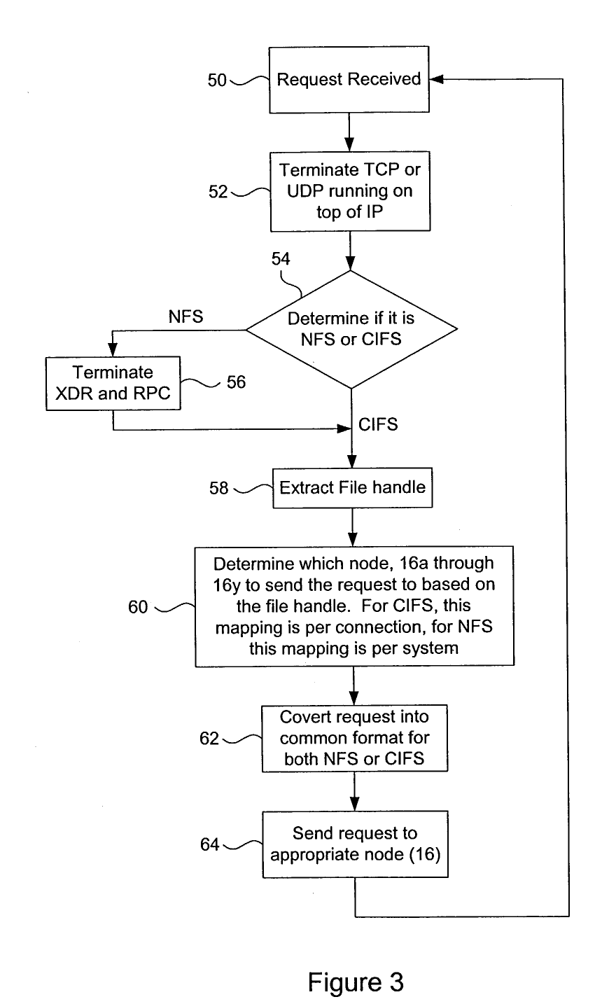

Referring to FIG. 3, a flow chart illustrating the operation of a termination node 14 is shown. When a request is received from the load balancer 12 (box 50), the responsible termination node 14 terminates either the TCP or UDP protocol running on top of IP (box 52). Thereafter, the terminate node 14 determines if the request is either NFS or CIFS (decision diamond 54). If NFS, then the termination node 14 terminates XDR and RPC (box 56). After the XDR and RPC termination, or if the request was CIFS, the termination node 14 next extracts the file handle defined by the request (box 58). The termination node 14 then determines or maps the appropriate file server node 16 to send the request to based on the extracted file handle. For CIFS requests, this mapping is per connection. For NFS requests, the mapping is per system (box 60). In other words, a given file handle may imply one file for a given CIFS connection and the same file handle may imply a different file for a different CIFS connection. Each CIFS connection must therefore keep its own mapping of either a File handle to a node 16 or a file handle to an internal version of the file handle which is consistently mapped to a file for the entire NAS system. The NFS file handles, on the other hand, are already consistent for the entire NAS system, i.e., the file handle to file mapping for one NFS connection is exactly the same on all NFS connections. The termination node 14 converts the request into a common format for both NFS and CIFS (box 62) and then sends the converted request to the appropriate file server node 16 (box 64). The aforementioned sequence is repeated for subsequent requests that are received.

The file server nodes 16 also perform a number of functions within the NAS system 10. Foremost, each file server node 16 implements its own file system. Accordingly, each file server node 16 is responsible for retrieving files through the disk controllers 18a-18z as necessary to service received requests. Each file server node 16 is also responsible for terminating the requests received from the termination nodes 14 and the disk controller nodes 18.

According to one embodiment, the file server nodes 16 implement a “federated” or “loosely coupled” file system. Each file server node 16 does not have to communicate with the other file server nodes 16 within the NAS system 10. This makes the file server nodes 16 scalable because each file server node 16 does not have to monitor or keep track of the files the other file server nodes 16 are accessing. Each file server 16 need not check or “ask permission” from the other file server nodes 16 before attempting to access a file. This arrangement significantly reduces management overhead within the NAS system 10.

The individual file sever nodes 16 also take responsibility for their name space ranges at the file level. In other words, the granularity of the division of responsibility for the name space between various file server nodes is at the file level. The division of labor among the various file server nodes 16 for regions of the name space, however, may vary dynamically. Any changes in the name space are propagated back to the termination nodes 14 so that they know which file server node 16 is responsible for a particular request (associated with a particular file) from the users.

According to one embodiment, the file server nodes 16 communicate with one another upon creation or transfer of name space among the file server nodes 16. For example, if one file server node has too large a name space and becomes too busy handling all the requests within its name space, then some or all of that name space can be transferred to another file sever node 16. Each file server node 16 maintains a table that indicates the name space managed by each of the file server nodes 16a through 16y. When name space is transferred, the table of each file server nodes 16 is updated. Similarly, when name space is added to the NAS system 10, the table of each file server node 16 is again updated. It should be noted that it is not necessary or even desirable for each node 16 to keep a complete map of the name space. Therefore in alternative embodiments, each node 16 keeps track of its own name space, i.e. all the files it is currently responsible for, plus the location of all the files that were created on that node 16 that may have been moved to a different node.

It should be noted that the termination nodes 14 should be made aware of the current name space mapping so that they can direct the terminated requests accordingly. If a termination node 14 has a name space mapping that is out of date, it may send the request to the wrong server node 16. That server node 16 may then have to inform the requesting termination node 14 of the change to the name space and the termination node 14 will have to re-issue the request to the correct server node 16.

Each server node 16 therefore keeps track of which server node 16 created a file and where the files have migrated. Consider an example where server node 16a creates file handles in the range 0-999, server node 16b creates file handles in the range 1000-1999, and server node 16c creates file handles in the range 2000-2999. All of the termination nodes 14 are aware of this static configuration and direct file requests accordingly. Assume that server node 16a creates a file “A” with file handle 321. The termination nodes 14 all know that when they see a reference to file handle 321, it falls in the range 0-999 and therefore is sent to server node 16a.

Now assume that file “A” migrates from 16a to 16b due to load balancing. If a request comes into termination node 14a for file handle 321, termination node 14a will send the request to server node 16a. However, server node 16a knows that file handle 321 has migrated to server node 14b. Consequently, server node 16a send a message back to termination 14a informing it that file handle 321 is now being handled by server node 16b. Termination node 14a will then send the request to server node 16b and updates this exception to its mapping table for all subsequent requests for file handle 321. All subsequent requests for file A will then be forwarded directly to server node 16b by termination node 14a.

Assume again that the same file “A” is migrated from server node 16b to 16c. When a another request for file A is received, termination node 14a notes the exception to its mapping table for file handle 321 and sends the request to server node 16b. The server node 16b knows that file handle 321 has migrated to some other node and therefore responds to termination 14a to remove the exception. Termination node 14a then sends the request to server node 16a according to the default mapping. Server 16a responds back to termination 14a that it should send this and all subsequent requests for file handle 321 to server node 16c. All subsequent requests are handled by server node 16c until file A migrates to another server node and the above update sequence is repeated.

It is useful to note that with this scheme, the state of all the files does not have to be updated atomically. Only one server node 16 needs to know where a particular file is at any point in time. In the example above, the server node 16a keeps track of the location of file handle 321. Since this information does not need to be distributed atomically, the present invention provides a highly scalable NAS solution.

Another noteworthy aspect with this scheme is that the server node 16 that creates a file handle is responsible for permanently storing information related to that file handle. This is required so that the system 10 knows where all the files are after a catastrophic event, such as a power failure. Since the server node where the file was created (node 16a in the example for file “A”) is the single authority of where the file is, it is the only server node responsible for writing this information into stable storage.

In alternative embodiments, updates to the mapping scheme may be implemented in a variety of ways different than the exception handling scheme described above. For example, the 16 nodes can propagate mapping exceptions to the termination 14 nodes as they occur in the background without substantially interfering with normal communications between the two sets of nodes 14 and 16. If that propagation has completed, there is no redirection. If it has not completed, there may be some redirection. Overall, since this redirection typically does not happen because the file has not moved or the exception entries are already in node 14, or has one level of indirection because a double move is rare, the total performance impact is negligible. “redirection” occurs when node 16a informs node 14a that file 321 is located on node 16b in the first part of the above example. “propagation” is when the 14 nodes are informed that file 321 has moved to node 16b before the nodes 14 even try to access file 321. This propagation will effectively eliminate the redirection previously described. Since redirection will likely have some performance impact due to the time and processing requirements for the additional messages back and forth between the 14 nodes and the 16 nodes, it is desirable to avoid redirection. There is, however, a window of time between when a file has moved from 16a to 16b until when each of the 14 nodes have updated their mapping table to reflect that move. If a file request comes in from the network during this window of time, there are two possible ways to handle this: (i) block all node 14 access to a file that is moving until the move has completed and the mapping table in all the nodes 14 have been updated; or (ii) allow the node 14 to access the file at any time including during the window that the node 14 has inaccurate information about where the current location of the file is and to handle this case with redirection. The second option is a practical way to handle the problem and it is a reasonable solution from a performance perspective because the overhead for redirection is not particularly large. In addition, with propagation of the mapping exceptions from nodes 16 to nodes 14, the probability that an access occurs for a file while the nodes 14 have the wrong location information for that file is fairly small. This further reduces the performance impact of moving files between different nodes 16.

The exception information could also be kept in a central location so that each server node 16 only needs to know about the files it is currently responsible for. If it gets a request for a file handle of a file it does not currently have, it will direct the termination node 14 to consult the central data base of exceptions for the current location of the file. This has the benefit that the server nodes 16 only need to keep information for the files that they have which they are required to maintain anyway.

According to yet another embodiment, the file server nodes 16 can be configured to cache recently and/or frequently accessed files. The advantage of maintaining cache copies is that these files can be immediately served by the file server nodes 16 without the delay of accessing the disks 20. Files can be cached based on the principles of either temporal or spatial locality, or a combination thereof. The cached files can be replaced using any appropriate replacement algorithm for the kind of file being accessed, such as Last Recently Used or first-in first-out for example.

It should be noted that the file server nodes 16 do communicate with one another to detect failures for redundancy purposes. This communication, however, is relatively insignificant and does not vary depending on the load volume on the system 10.

According to various embodiments, the file server nodes 16 may implement either a dynamic distributed file system such as CODA or a clustered file system. For more information on CODA, see for example “The Coda Distribution File System”, by Peter J. Braam, School of Computer Science, Carnegie Mellon University, incorporated by reference herein. Other file systems that may be used include for example UFS (Unix File System) or AFS (Andrew File System).

According to another embodiment, the file server nodes 16 are each capable of locking a file that it is accessing in accordance with a number of possible locking semantics. With exclusive locks for example, access of a file accessed by one file server node 16 would lock out both reads and write attempts by other file server nodes 16. Alternatively, if one file server node 16 is writing to a file, it will place a lock on that file to prevent a second client from writing to that file. However, a read access may be permitted.

Finally, as previously noted, the individual file sever nodes 16 can be configured or optimized for handling specific types of requests. With the MPEG example, the responsible file server node 16 can be optimized to pre-fetch the blocks of data from the disks 20 based on the assumption that all the frames in the MPEG file will need to be served. In another example, if a file is used for a database index, an optimization may be to provide more cache memory. This would reduce the occurrence of pre-fetching since the data access pattern will likely be random with bursts of activity on the same location of a file. In another example involving a log file, a single read cache and a relatively large amount of write cache may be provided since the data is primarily write-only and is read only during error recovery. In yet another example, generally small web type files you may be optimized by using a block layout on the disk that is optimized for reads versus writes and for small files versus large files. It should be noted that numerous other specific optimizations could be implemented and that those provided above are merely illustrative and should not be construed as limiting in anyway.

The disk controller nodes 18 are responsible for managing the disks 20 respectively. As such, the disk controller nodes 18 are responsible for file mirroring, relocation, and other disk related activities such as those associated with whatever level of RAID is used in the system 10. In addition, the disk controller nodes 18 terminate any requests received from the file server nodes 16, virtualize physical disk space, access the appropriate storage blocks to retrieve requested files, and act as a data block server. The controller nodes 18 also monitor their disks 20 for failure and replacement, and perform mirroring of the data stored on the disks for back-up purposes.

As previously noted, the disks 20 can be arranged in any type of configuration, such as RAID 1 for example. If the disk controller nodes 18 implement RAID 1 for example, they will mirror all the data across two or more physical disks, i.e. each disk controller node 18 will create two copies when a write occurs and will read only one of the copies when a read occurs. With this implementation, server node 16, on the other hand, thinks that it is writing to a single, standard disk. But in reality, it is writing to a virtual disk that node 18 then implements in physical disk space. In other words, the virtual view of the storage is different than the physical implementation. In another example, consider a large file system of 360 Gbytes. Currently a single disk of this size is not feasible. Since file systems typically cannot span multiple disks, the file system running on the server node 16 must see a disk that is at least 360 Gbytes. Consequently, the disk controller nodes 18 have to logically concatenate a number of physical disks together to present the desired disk space to the server node 16. In alternative embodiments, other types of storage mediums may be used, such as electro-magnetic tape, CD-ROM, or silicon based memory chips.

The switching fabric 22 includes a number switches. In various embodiments, the switching fabric can include Fibre Channel switches, Ethernet switches, or a combination thereof. Similarly, a number of different communication protocols can be used over the switching fabric. For example, TCP/IP or FCP running over Ethernet or Fibre Channel, could be used as the communication protocol across the switching fabric 22. In one embodiment, a protocol specifically designed for the NAS system 10, hereafter referred to as the “ABC” protocol, may be used. For a more detailed explanation of the ABC protocol, see U.S. patent application Ser. No. ______, entitled Apparatus and Method for a Lightweight, Reliable, Packet-Based Transport Protocol (Attorney Docket No. ANDIP018), filed on the same day as the present application and assigned to the same assignee, incorporated by reference herein for all purposes.

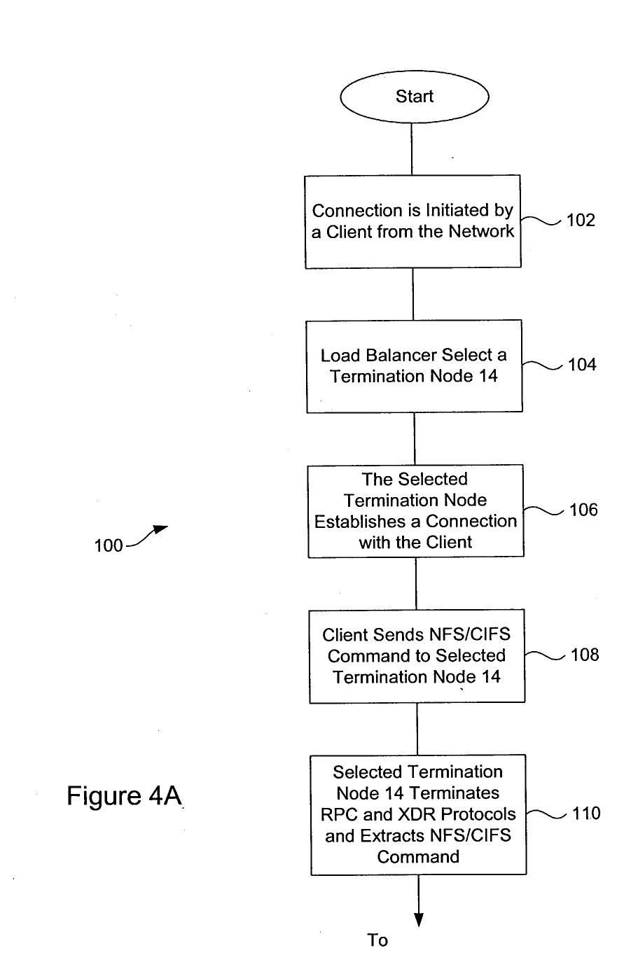

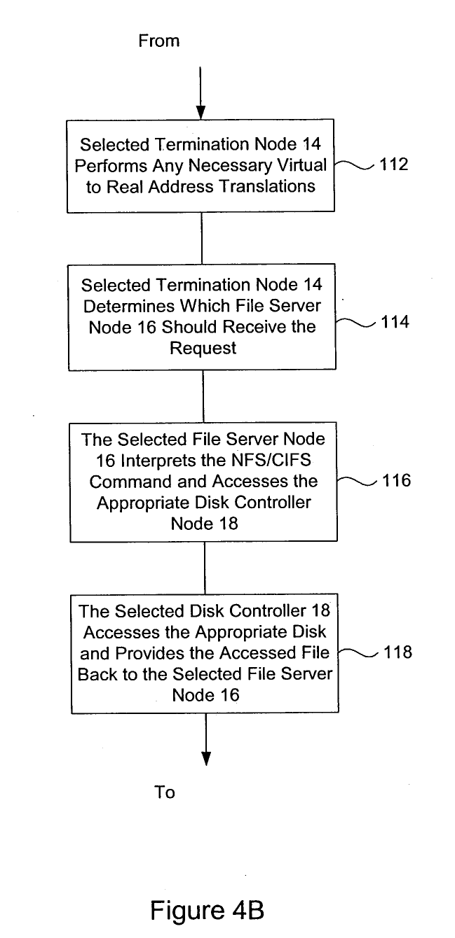

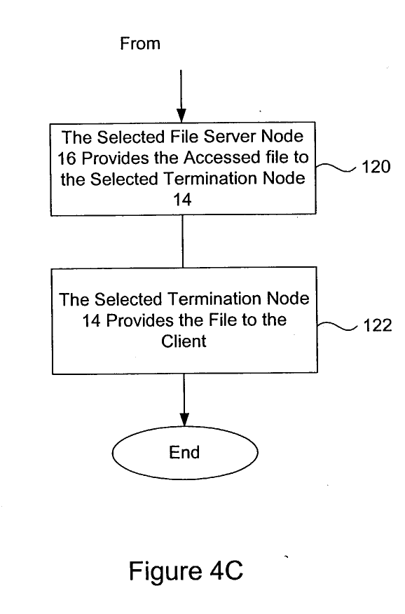

Referring to FIGS. 4A through 4C, flow diagrams illustrating how the NAS system 10 processes a request from a client according to the present invention is shown.

As illustrated in FIG. 4A, when a client in the network 24 wishes to access the NAS system 10, the client initiates a connection through the network 24 (box 102). The load balancer 12, in response, selects a termination node 14 as described above (box 104). The selected termination node 14 establishes a connection with the client (box 106). The client then sends the NFS/CIFS command to the selected termination node 14 (box 108) which terminates the TCP/IP request and extracts the NFS/CIFS command (box 110).

As illustrated in FIG. 4B, the selected termination node 14 performs any necessary virtual to real file address translations (box 112) and then determines which file server node 16 should receive the request. As previously noted, the file server node 16 is generally selected based on the contents of the request (box 114). The selected file server node 16 interprets the NFS/CIFS command and accesses the appropriate disk controller node 18 (box 116). Thereafter, the desk controller node 18 accesses the appropriate disk 20 and provides the requested file to the selected file server node 16 (box 118).

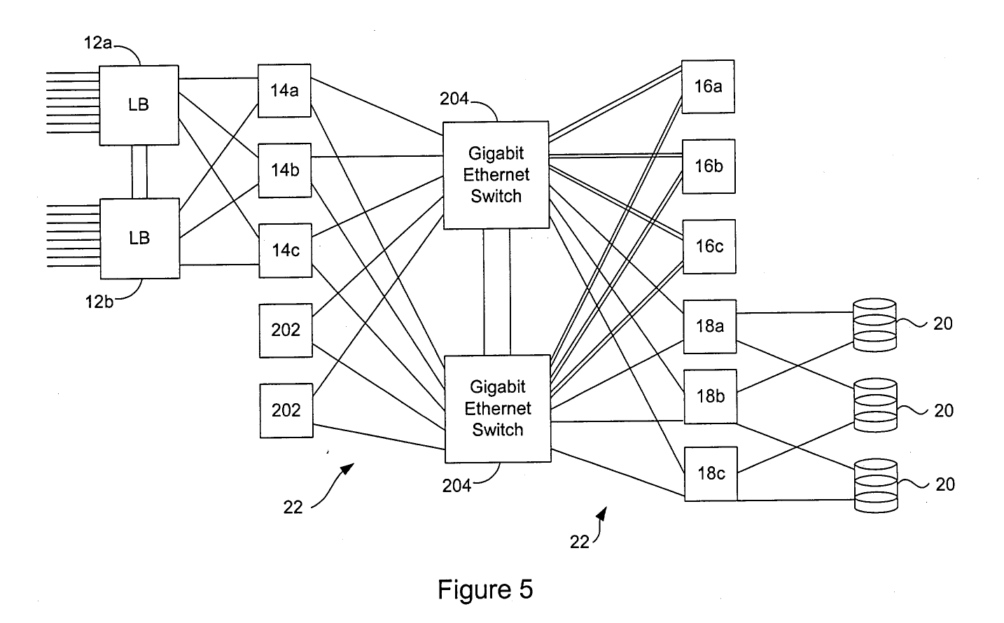

Finally, as illustrated in FIG. 5C, the file server node 16 provides the file to the selected termination node 14 (box 120), which in turn, provides the file to the client over the network 24 (box 122).

Referring to FIG. 5, a block diagram illustrating an implementation of the NAS system according to one embodiment of the of the present invention is shown. The NAS system 200 includes a pair of load balancers 12a and 12b, a pair of general nodes 202a and 202b, a plurality of termination nodes 14a through 14c, a plurality of file server nodes 16a through 16c, a plurality of disk controller nodes 18a through 18c, and a plurality of disks 20 associated with the disk controller nodes 18a through 18c respectively. The switching fabric 22 of this embodiment includes two Gigabit Ethernet switches 204. Redundant connections are provided between each of the above listed elements for high performance and as back-up in the event one of the connections goes down. The “general nodes 202” are responsible for management of the system. For example, when the administrator logs into the file server to set quotas for users or to setup user access control, the administrator must do this through a node in the system 200. It could be handled by any node in the system, but if there is a dedicated node (or two for redundancy) it makes the implementation easier. Basically the general nodes 202 are responsible for system configuration and management. They do not participate in the data path of file access. They may be used for determining when various nodes fail and for implementing policies for data migration from one node 16 to another, all of which do not impact performance.

In this embodiment, TCP/IP is used for communications between users on the network 24 and the termination nodes 14. The ABC protocol is used for communication between the termination nodes 14 and the file server nodes 16. SCSI over ABC is used for communications between the file server nodes 16 and the disk controller nodes 18. Finally, SCSI over Fibre Channel is used for communications between the disk controller nodes 18 and the disks 20.

In one embodiment of the invention, the load balancers 12a and 12b can be implemented in software or microcode executed on one or more computers. In alternative embodiments, the load balancers 12a and 12b can be implemented in hardware system including one or more application specific logic chips, programmable logic devices such as a Field Programmable Logic Device, or a combination thereof. Similarly, both the termination nodes 14 and the file server nodes 16 can be implemented on computers, such a server, dedicated hardware, programmable logic, or a combination thereof. Furthermore, one or more of the termination nodes 14 and the file server nodes 16 may be in a single CPU or multiple CPUs and the switching fabric may be replaced by inter or intra CPU communication mechanism(s).

The termination nodes 14, file server nodes 16, and the disk controller nodes 18 are each independently scalable within the NAS system of the present invention. If one type of node becomes over-loaded, then additional nodes of that type can be added to the system until the problem is corrected.

The embodiments of the present invention described above are to be considered as illustrative and not restrictive. The invention is not to be limited to the details given herein, but may be modified within the scope and equivalents of the appended claims.

We claim:

1. An apparatus comprising:
a scalable network attached storage system, the network attached storage system comprising:
one or more termination nodes;
one or more file server nodes for maintaining file systems respectively;
one or more disk controller nodes for accessing storage disks respectively; and
a switching fabric coupling the one or more termination node, file server nodes, and disk controller nodes,
wherein the one or more termination nodes, file server nodes and disk controller nodes can be added or deleted to the scalable network attached storage system as needed.

2. The apparatus of claim 1, further comprising a load balancer configured to be coupled to the termination nodes, the load balancer configured to balance the load of connections among the one or more termination nodes.

3. The apparatus of claim 2, wherein the load balancer balances the load of connections among the one or more termination nodes based on one or more of the following metrics: the number of connections per termination node; utilization of the termination nodes; memory utilization; or a combination thereof.

4. The apparatus of claim 2, wherein the load balancer is further configured to maintain a current list of the termination nodes as they may be added or deleted from the scalable network attached storage system.

5. The apparatus of claim 2, wherein the load balancer is further configured to forward all requests associated with a connection to the same termination node as the requests are received.

6. The apparatus of claim 1, wherein each of the one or more termination nodes is configured to terminate requests as they are received.

7. The apparatus of claim 6, wherein the requests are either TCP or UDP running on IP.

8. The apparatus of claim 6, wherein the termination nodes are further configured to determine if any received requests are NFS or CIFS.

9. The apparatus of claim 8, wherein the termination nodes are further configured to terminate XDR and RPC for NFS requests.

10. The apparatus of claim 6, wherein the one or more termination nodes are configured to extract the file handle from any request it receives respectively.

11. The apparatus of claim 10, wherein the one or more termination nodes are configured to send the request to a selected one of the file server nodes based on the extracted file handle.

12. The apparatus of claim 11, wherein the one or more termination nodes are configured to send the request to the selected one of the file server nodes in a common format regardless if the request was NFS or CIFS.

13. The apparatus of claim 6, wherein the one or more termination nodes are configured to send the request to a selected file server node based on the type of file defined by the request.

14. The apparatus of claim 1, wherein the one or more termination nodes are configured to detect failures of the one or more file server nodes.

15. The apparatus of claim 1, wherein the one or more file server nodes are each configured to retrieve files through the one or more disk controller nodes as necessary to service any received requests.

16. The apparatus of claim 1, wherein the one or more file server nodes are each configured to terminate any requests received from the termination nodes and the disk controller nodes.

17. The apparatus of claim 1, wherein each of the one or more file server nodes maintains a federated file system that does not keep track of the files accessed by the other file server nodes.

18. The apparatus of claim 1, wherein the file systems maintained by each of the one or more server nodes services a different name space range respectively.

19. The apparatus of claim 18, wherein the different name space ranges serviced by the one or more server nodes is allocated dynamically.

20. The apparatus of claim 19, wherein the name space allocated to each of the one or more server nodes is dynamically propagated to the one or more termination nodes.

21. The apparatus of claim 1, wherein each of the file server nodes is capable of locking a file when accessing that file.

22. The apparatus of claim 21, wherein the file is locked when being read, when being written, or both.

23. The apparatus of claim 1, wherein the one or more file server nodes are each further configured to maintain a cache of recently accessed files that can be served without accessing the storage disks respectively.

24. The apparatus of claim 23, wherein the files in the caches are replaced using a replacement algorithm, the replacement algorithm being one of the following: last recently used, or first in first out.

25. The apparatus of claim 1, wherein the one or more file server nodes are optimized for handling certain types of specific requests.

26. The apparatus of claim 1, wherein the storage disks are arranged in one or more redundant arrays of independent disks.

27. The apparatus of claim 1, wherein each of the disk controller nodes performs one or more of the following functions: file mirroring for backup purposes, file relocation, terminate requests received from the one or more file server nodes, virtualization of disk space, monitor the storage disks for failure and replacement, and act as a data block server.

28. The apparatus of claim 1, wherein the switching fabric comprises the following types of switches: Ethernet switches, Fibre Channel switches, or a combination thereof.

29. The apparatus of claim 1, further comprising a storage array network coupled between the one or more disk controller nodes and the storage disks.

30. The apparatus of claim 1, one or more of the termination nodes and the file server nodes are implemented in one or more CPUs the switching fabric is at least partially implemented using an inter and/or an intra CPU communication mechanism.

31. A method comprising:
receiving a connection request from a client;
selecting a termination node among the plurality of termination nodes to establish a connection with the client in response to the connection request based on a predetermined metric;
terminating at the selected termination node a command request received from the client during the connection by extracting a file handle defined by the command request;
forwarding the command request to a selected file server node among a plurality of file server nodes;
interpreting the command request at the selected file server node and accessing an appropriate disk controller node among a plurality of disk controller nodes; and
accessing disk storage through the appropriate disk controller node and serving the accessed data to the client.

32. The method of claim 31, wherein the predetermined metric comprises one of the following: the load among the plurality of termination nodes, CPU utilization, memory utilization, or a combination thereof.

33. The method of claim 32, wherein the forwarding of the command request to a selected file server node based on the file handle extracted from the command request.

34. The method of claim 32, wherein the forwarding of the command request to a selected file server node based on the type of file defined by the command request.

35. The method of claim 31, further comprising scaling the number of termination nodes, file server nodes, and disk controller nodes as needed to meet user demands.
